(19) United States
(12) Patent Application Publication
(10) Pub. No.: US 2009/0267767 A1
(43) Pub. Date: Oct. 29, 2009

(54) Radio Frequency Identification Tag for a Mobile Phone

(76) Inventor: Chris CHEN, Kaohsiung City (TW)

Correspondence Address: Dr. BANGER SHIA, 102 Lindencrest Ct., Sugar Land, TX, 77479-5201, US

(21) Appl. No.: 12/108,906

(22) Filed: Apr. 24, 2008

(51) Int. Cl. G08B 13/22

(52) U.S. Cl. 340/572.1

(57) ABSTRACT

A radio frequency identification tag for a mobile phone comprises a combination layer, a radio frequency identification layer and an anti-slip layer. By such arrangements, the radio frequency identification tag can provide the mobile phone with a wireless identification function.

### BACKGROUND OF THE INVENTION

1. Field of the Invention

The present invention relates to a laminated product, and more particularly to a radio frequency identification tag for a mobile phone for providing the mobile phone with a wireless identification function.

2. Description of the Prior Art

Nowadays, with the communication convenience brought by the development of electronic products, mobile phone has become more and more indispensable in people's daily life. Since the housings of the conventional mobile phones are usually made of plastic or metal which has a low friction coefficient, this makes the mobile phone more likely to slip out of the user's hand or the surface of an object on which it is placed and cause damage.

In order to solve the above problems, an anti-slip tag for the mobile phone appears on the market, which comprises a coating layer 11 and an elastic layer 13. The coating layer 11 is adhered to the elastic layer 13 to form the anti-slip tag 10. Referring to FIG. 2, the anti-slip tag 10 is adhered to the mobile phone by the coating layer 11, and the elastic layer 13 serves to increase the friction between the mobile phone and the object it contacts. Although the problem of lack of the friction is solved, the function of the anti-slip tag 10 is very limited since it only has the function of increasing the friction.

The present invention is aimed at improving the added value of the anti-slip tag 10.

### SUMMARY OF THE INVENTION

The primary objective of the present invention is to provide a radio frequency identification tag for a mobile phone for providing the mobile phone with a wireless identification function.

In order to achieve the above objective, the radio frequency identification tag for the mobile phone in accordance with the present invention comprises a combination layer, a radio frequency identification layer and an anti-slip layer. The combination layer is made of cohesive material and is adhered to the mobile phone. The radio frequency identification layer includes a wafer and an antenna and is attached to the combination layer. The anti-slip layer includes a combination portion, a decorative portion and an elastic portion, the combination portion is made of cohesive material, and the anti-slip layer is adhered to the radio frequency identification layer by the combination portion.

The advantages of the present invention are described as follows:

The radio frequency identification tag is used on the mobile phone. Due to the characteristic of the mobile phone of being portable, plus the radio frequency identification tag can provide the mobile phone with a wireless identification function. Thus, the added value of the radio frequency identification tag can be improved.

### BRIEF DESCRIPTION OF THE DRAWINGS

FIG. 1 is a cross sectional view of a conventional tag;

FIG. 2 is a view showing that the conventional tag is used on a mobile phone;

FIG. 3 is a first cross sectional view of a radio frequency identification tag in accordance with the present invention;

FIG. 4 is a second sectional view of the radio frequency identification tag in accordance with the present invention; and

FIG. 5 is a view showing that the radio frequency identification tag of the present invention is used on the mobile phone and cooperates with a card reader.

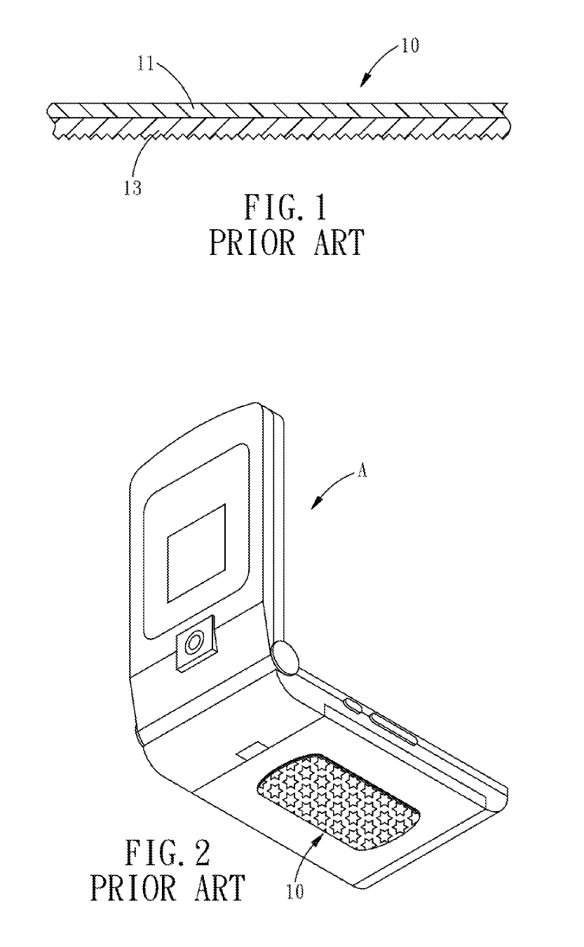

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

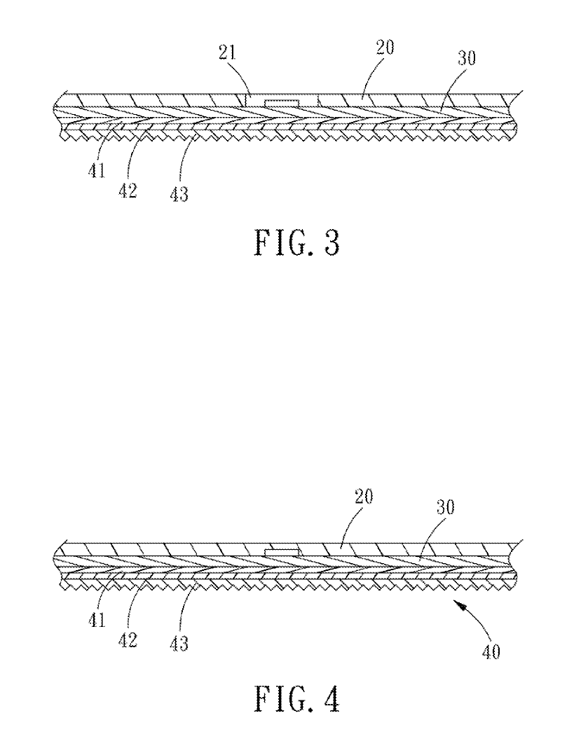

Referring to FIG. 3, a radio frequency identification tag used on a mobile phone A in accordance with the present invention comprises a combination layer 20, a radio frequency identification layer 30 and an anti-slip layer 40.

The combination layer 20 is made of cohesive material and is provided with a through hole 12.

The radio frequency identification layer 30 is adhered to the combination layer 20 and includes a wafer and an antenna. The wafer of the radio frequency identification layer 30 has a predetermined thickness which is less than the thickness of the combination layer 20. The wafer of the radio frequency identification layer 30 can be engaged in the through hole 21 of the combination layer 20, and the radio frequency identification tag for the mobile phone is flatly attached to the surface of a mobile phone A. Referring to FIG. 4, the combination layer 20 is not necessarily provided with the through hole 21, it can be attached to the wafer and the antenna of the radio frequency identification layer 30 directly.

The anti-slip layer 40 includes a combination portion 41, a decorative portion 42 and an elastic portion 43. The combination portion 41 is made of cohesive material, the decorative portion 42 can be shape, pattern, color or a combination thereof, and the elastic portion 43 is made of transparent rubber. The anti-slip layer 40 is adhered to the radio frequency identification layer 30 by the combination portion 41, so that the anti-slip layer 40, the radio frequency identification layer 30 and the combination layer 20 are laminated together.

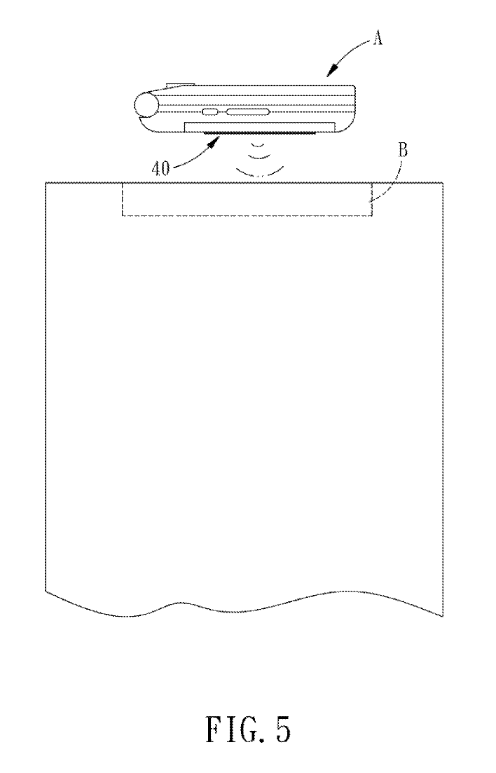

For a better understanding of the present invention, its operation and function, reference should be made to the FIG. 5, the radio frequency identification tag is attached to the mobile phone A by the combination layer 20. The radio frequency identification layer 30 can be used in electronic toll collection and access control because of its store and calculation function. In the applications of electric toll collection and access control, the radio frequency layer 30 is used as digital storage and digital identifier, respectively. To realize the function of digital storage and digital identification, the radio frequency identification layer 30 of the abovementioned radio frequency identification tag should cooperate with a card reader B.

While we have shown and described various embodiments in accordance with the present invention, it is clear to those skilled in the art that further embodiments may be made without departing from the scope of the present invention.

What is claimed is:

1. A radio frequency identification tag for a mobile phone, comprising:
a combination layer being made of cohesive material and adhered to a mobile phone;
a radio frequency identification layer including a wafer and an antenna and being adhered to the combination layer; and
an anti-slip layer including a combination portion, a decorative portion and an elastic portion, the combination portion being made of cohesive material, and the anti-slip portion being adhered to radio frequency identification layer by the combination portion.

2. The radio frequency identification tag as claimed in claim 1, wherein the decorative portion includes shape, pattern, color or a combination them.

3. The radio frequency identification tag as claimed in claim 1, wherein the combination layer is provided with a through hole, the radio frequency identification layer is adhered to the combination layer, and the wafer of the radio frequency identification layer is engaged in the through hole of the combination layer.

4. The radio frequency identification tag as claimed in claim 1, wherein the radio frequency identification layer has a thickness which is less than a thickness of the combination layer.
